(19) United States
(12) Patent Application Publication
(10) Pub. No.: US 2008/0244022 A1
(43) Pub. Date: Oct. 2, 2008

(54) EMAIL TEMPLATES FOR PERSON TO PERSON COMMUNICATIONS

(76) Inventor: John W. Johnson, Sparks, NV (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 11/925,696

(22) Filed: Oct. 26, 2007

Related U.S. Application Data
(60) Provisional application No. 60/863,129, filed on Oct. 26, 2006.

(51) Int. Cl. G06F 15/16

(52) U.S. Cl. 709/206

(57) ABSTRACT

Systems and methods are described for customizing electronic communications and systems. In particular, methods for generating and using templates are described. Email is typically customized according to a scheme or format selected by the user and in accordance with an affinity of the user with an organization, sports team or an event. Participants in a sporting activity may choose to participate in disclosed systems on behalf of the league or sporting organization's members. Text and graphical content provided by participants may be associated with links to dynamically provided information. Content providers may offer a plurality of templates including branded messaging such as E-mail featuring images and brand related to sports, motion picture, arts, entertainment and hobbies. Templates may include advertising content allowing a service provider to generate revenue from ad placement. A toolbar is described that permits subscribers to choose whether a template should be added to the message.

### CROSS-REFERENCE TO RELATED APPLICATIONS

The present application claims priority from provisional patent application No. 60/863,129 entitled “Email Templates for Person to Person Communications,” filed Oct. 26, 2006, which is incorporated herein by reference and for all purposes.

### BACKGROUND OF THE INVENTION

1. Field of the Invention

The present invention relates generally to systems and methods for customizing messages and more particularly to systems and methods for customizing Email messages using branded content having an affinity to a sports, arts or other organization.

2. Description of Related Art

E-mail systems and other messaging systems are prevalent. However, conventional systems are minimally configurable, permitting only a limited number of options for providing customization for users of the systems. Conventional systems have limited server-generated templates and these latter templates tend to provide advertising space only. Users of the systems do not have an ability to create complex customized templates that can be easily enabled and disabled. Typically, conventional systems do not allow users to show an affinity with sports or other organizations.

Furthermore, the on-line marketing industry has had very limited success in attempts to penetrate the millions of personal in-boxes of E-mail users without using E-mail blasting/SPAM technology.

### BRIEF SUMMARY OF THE INVENTION

Certain embodiments of the invention provide systems and methods for customizing electronic communications and systems and methods for generating and using templates as both business-to-business and consumer communication solutions. The systems and methods provided can be used to leverage affinities with colleges, universities, sports and other organizations in order to promote, for example, fan alliances, alumni associations, club interests and so on. In certain embodiments, user Email may be customized according to a scheme or format selected by the user. The scheme or format may be selected in accordance with an affinity of the user with an organization, sports team or an event, etc.

In certain embodiments, participants in a sporting activity may choose to participate in systems provided in accordance with certain aspects of the invention. In some embodiments, a league or sporting organization may choose to participate in systems provided in accordance with certain aspects of the invention on behalf of the league or sporting organization's members. In certain embodiments, text and graphical content provided by participants may be associated with links to dynamically provided information. In one example, an image related to an event such as a NASCAR race may be provided with a hyperlink that leads a user to a World Wide Web site (“Website”) updated by a team, an individual or the NASCAR organization.

In certain embodiments, a content provider may offer a plurality of templates. In one example, a provider may offer premier templates that include branded messaging such as E-mail featuring images and brand related to sports, motion picture, arts, entertainment and hobbies. In certain embodiments, templates may include advertising. Advertising allows a service provider to generate revenue from ad placement.

Certain embodiments provide a toolbar that permits subscribers to choose whether a template should be added to the message. Thus when a message is composed, the template can be inserted automatically into the E-mail client. The toolbar is typically provided as a plug-in to an E-mail client application including web based E-mail clients.

In certain embodiments, an advertiser can provide a graphic for placement in the template. Typically the graphic is identifiable with the advertiser and may contain a logo, trademark, service mark, icon, an example of packaging, product image or other image recognizable by a viewer as relating to the advertiser.

### BRIEF DESCRIPTION OF THE DRAWINGS

FIG. 1 is a simplified block diagram of a system according to aspects of the invention;

FIG. 2 is a flowchart depicting an example of a process for sending a message according to certain aspects of the invention;

FIG. 3 is a flowchart depicting an example of a process for configuring a system according to certain aspects of the invention;

FIG. 4 is a screen shot of an example E-mail created according to aspects of the invention;

FIGS. 5-6 are screen shots of a web client having an integrated toolbar provided according to certain aspects of the invention; and

FIGS. 7-10 show screen shots associated with the configuration of a templates according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements.

Certain embodiments of the invention provide templates as a business to business communication solution. In particular, certain embodiments can be used to leverage affinities with colleges, universities, sports and other organizations in order to promote, for example, fan alliances, alumni associations, club interests and so on.

Certain embodiments of the invention provide systems and methods for customizing electronic communications. In certain embodiments, user Email may be customized according to a scheme or format selected by the user. The scheme or format may be selected in accordance with an affinity of the user with an organization, sports team or an event, etc. In one example, a user may select an Email formatting scheme based on a sports theme by specifying a sporting activity and/or a preferred participant or participating team of the selected sporting activity. In the example, a user may select a college football theme and identify a preferred college team such as Notre Dame, University of California, Stanford, UCLA, USC or any other participating college team.

In certain embodiments, participants in a sporting activity may choose to participate in systems provided in accordance with certain aspects of the invention. In some embodiments, a league or sporting organization may choose to participate in systems provided in accordance with certain aspects of the invention on behalf of the league or sporting organization's members. Thus, the participants can provide graphics, licensing and content that may be used in constructing a sporting theme for users of the system. Content may include graphics, images and/or video clips related to league, team or individual participants. Content may be updated at predetermined intervals or in response to events. For example, content associated with a basketball team may be updated before, during or after a basketball game. Thus, current images such as action shots may be available for inclusion in Emails created in accordance of aspects of the invention.

In certain embodiments, text and graphical content provided by participants may be associated with links to dynamically provided information. In one example, an image related to an event such as a NASCAR race may be provided with a hyperlink that leads a user to a World Wide Web site (“Website”) updated by a team, an individual or the NASCAR organization. A recipient of an Email created according to certain aspects of the invention may access the Website by clicking on an image, a graphic, text or an icon. Methods for embedding hyperlinks are known in the art as will be appreciated b those skilled in the art.

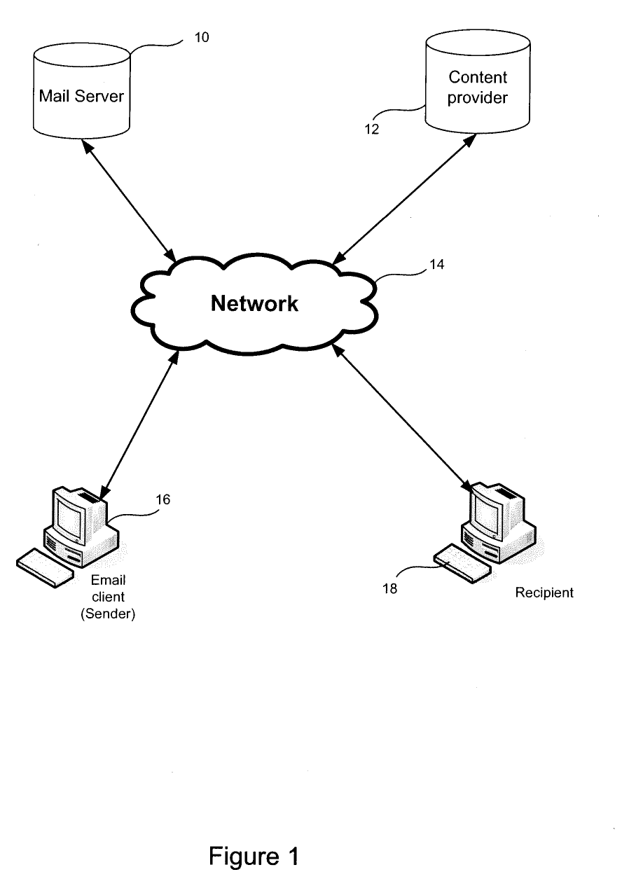

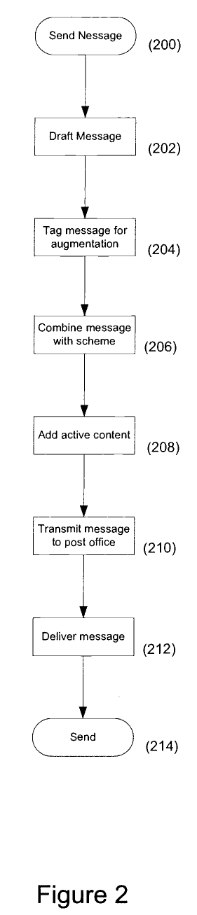

For the purposes of this discussion, the example of the operation of an Email system, modified according to certain aspects of the invention, will be described with reference to FIGS. 1 and 2. FIG. 1 provides a simplified schematic of one example of a system according to certain aspects of the invention, while FIG. 2 shows a simple flowchart of a process 200 used to send customized messages in the example embodiment. At step 202, a user creates a message, typically at an electronic device 16 such as a computer, a PDA, a cell phone, or any device equipped for the creation of an Email. When the message is ready for transmission, the message may be tagged at step 204 for augmentation with a personalized scheme. Tagging may be performed automatically based on the address to which the message is directed, information associated with the address provided by user, by predetermined rule or based on a history of prior transmissions to or from the addressee.

In one example, an address for the message may be selected from an address book associated with a user of an Email system where the address book includes a flag or indicator that the address can receive a message augmented as described herein. The indicator or flag may be manually set by the user or may be derived from previous messages received from the addressee. For example, the addressee may have been included in the address book upon receipt of a message from the addressee and, based on analysis of the message, it may be determined that the addressee can receive augmented messages.

In another example, the user may opt to have all messages augmented according to a desired personalization scheme. In any case, where an augmented message is sent to an addressee ill-equipped to process the personalization, then the message may be rejected. Upon rejection, the user's address book may be updated to reflect the addressee capabilities accordingly.

In certain embodiments, the personalization may be stripped from the message or represented using a text or graphical indicator. For example, where an Email message is personalized by adding a graphic and/or a link to a graphic resolvable when the message is to be displayed, the receiving Email client may discard the graphic or selectively ignore the link to the graphic. Typically, an Email client 18 will discard or ignore graphical content, ignore links to graphical content or reject a message when the client capabilities do not permit display of graphics, has insufficient resolution of the graphical content presented, has a low bandwidth communication link, by configuration of a receiving user or system and/or for security reasons.

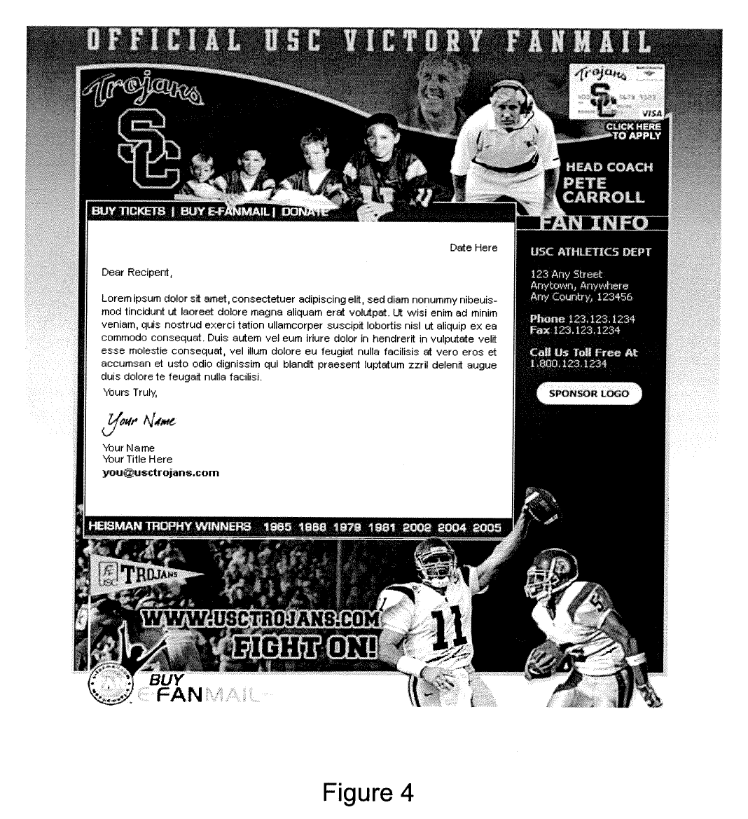

In certain embodiments, the message generated by the user is combined with personalization content at step 206. As depicted in the example screenshot in FIG. 4, personalization content can comprise combinations of a background, border and formatting components. An area is typically reserved for the user message and various information fields can be provided that identify the user (sender), the user contact information and so on. The personalization may relate to a sports team and can include graphics, logos, images and information related to the sports team. Furthermore, active content can be provided at step 208 that allows a recipient of the message to visit websites and/or receive additional content regarding the sports team. For example, a schedule of upcoming games could be presented to the recipient with a link to purchase tickets. Additionally, the recipient 18 may be offered information regarding the personalized messaging system, including options and opportunities for subscribing to the system.

In certain embodiments, a final augmented message is transmitted to a recipient 18 at step 210, typically using an Email or other messaging system 10 or component of such a system. The component may be a forwarding server or, in one example, an Exchange server. At some point, the message is delivered to the user at step 212.

In certain embodiments, the final message is viewed by the user prior to dispatch to a mail system. In some of these embodiments, content is assembled on a local Email client system or application before forwarding to the recipient. In certain embodiments, the Email client cooperates with a server to construct the augmented message, such that the server generates a scheme selected previously by the user and embeds the user message to generate the final message. In the latter example, the user may be provided with a view of the final message prior to dispatch.

In certain embodiments, a content provider may offer a plurality of templates. In one example, a provider may offer premier templates that include branded messaging such as E-mail featuring images and brand related to sports, motion picture, arts, entertainment and hobbies. A provider may also offer legacy or heritage templates that include branded E-mail featuring images and brands for sports teams or nostalgia images that are more than 10 years old and/or related to sports, motion picture, arts, entertainment and hobbies. Hall of fame templates may be offered that provide E-mail that features images and brands related to sports teams or nostalgia images of athlete, coaches and teams inducted into a hall of fame. Similarly, older materials (e.g. 25+ years) may be offered as classic templates.

In certain embodiments, a template may be provided to the user when the user elects to compose a message. Typically, the template includes the final form of graphics and content selected by the user and provides a message space and an address entry space for identifying the recipient.

In certain embodiments, the user may provide a message from a limited-capability device, such as a cell-phone, that cannot support the graphical content of the selected personalized scheme. In such embodiments, the user can transmit a text message and address of the recipient to a server which adds the scheme graphics and active content.

In certain embodiments, the scheme selected by the user can be updated from a content server 12. Content server 12 may update information and graphics prior to generation of a message and may update content prior to delivery to a recipient 18. In certain embodiments, content may be updated upon subsequent accesses of the message by recipient 18.

In certain embodiments, templates may include advertising. Advertising allows a service provider to generate revenue from ad placement. Ad placement in the templates can be directed to the content and/or area of interest addressed by the scheme. In certain embodiments, ad placement may be influenced by usage history of the user 16 and of the recipient 18. In certain embodiments, in-text placement is used on branded E-mail so that readers of the E-mail can see advertising prior to clicking on a brand or other content. In this manner, content can be monetized in real-time, enabling an incremental increase in ad revenue by providing a new source of untapped ad inventory that does not compete with the other ad programs provided within the service.

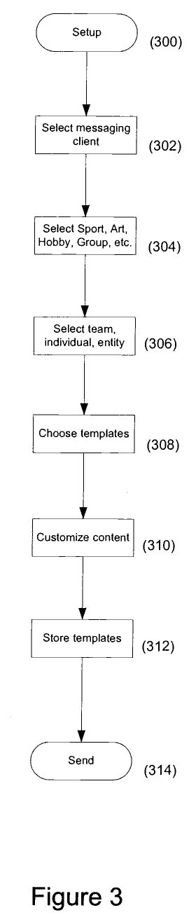

FIG. 3 depicts a method 300 for customizing E-mail according to certain aspects of the invention. A subscriber to the system will typically be prompted to customize and configure schemes for use in messaging. A subscriber may select a plurality of schemes and designate one of the schemes as a current scheme for general use. In certain embodiments, a subscriber may assign different schemes or variations of schemes for use in different contexts; for example, a subscriber may assign one or more schemes for use to groups of users in an address book. Additionally, a subscriber may suppress the addition of templates in certain circumstances; for example, a subscriber may elect to restrict the use of templates to messages directed predefined groups of users or may suppress templates for groups of users.

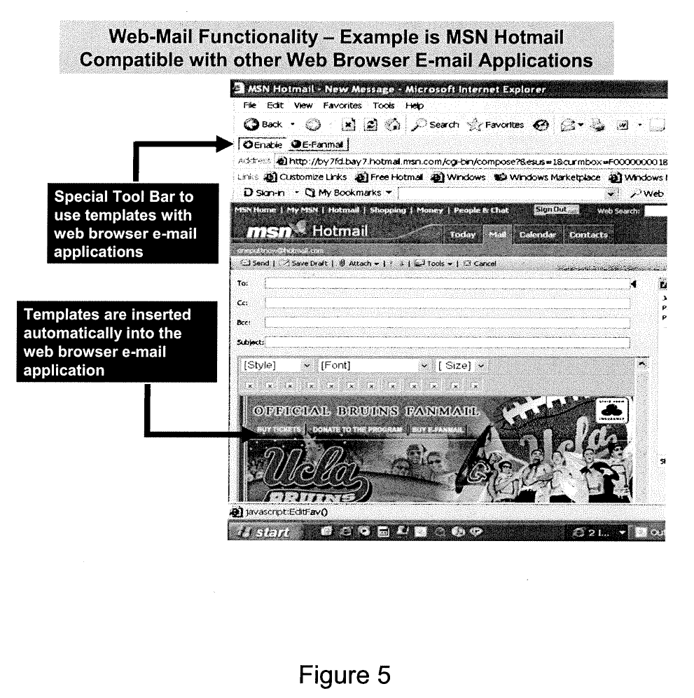

FIG. 5 shows a screenshot of one embodiment in which a tool bar is provided to a subscriber of an E-mail system and a system according to certain aspects of the invention. The toolbar allows the subscriber to choose whether a template should be added to the message. Thus when a message is composed, the template can be inserted automatically into the E-mail client. The toolbar is typically provided as a plug-in to an E-mail client application including web based E-mail clients. In certain embodiments, the toolbar may be provided for other types of message and for other social networking and collaborative systems.

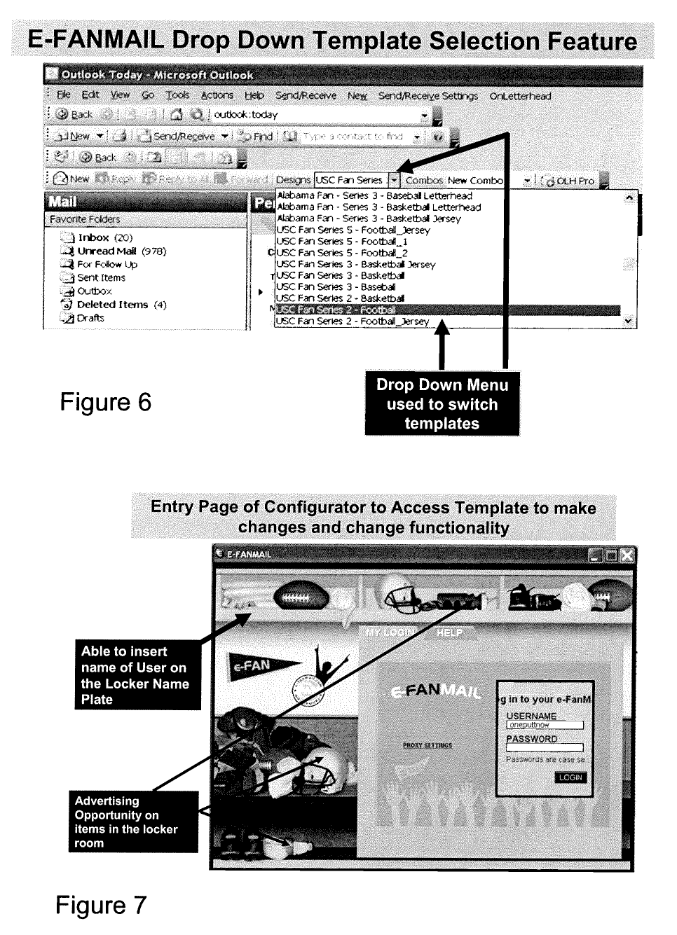

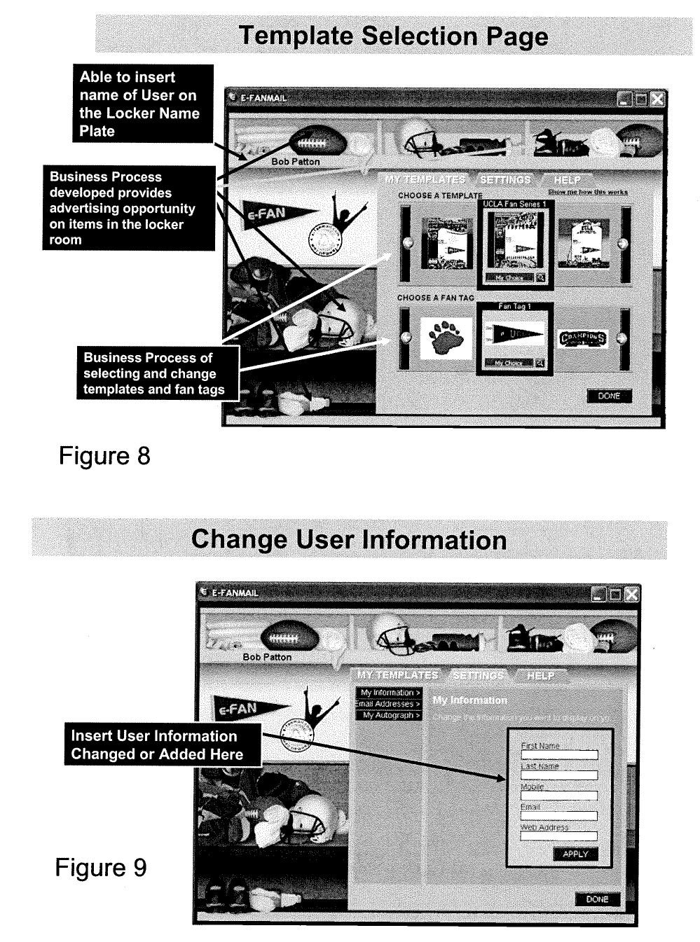

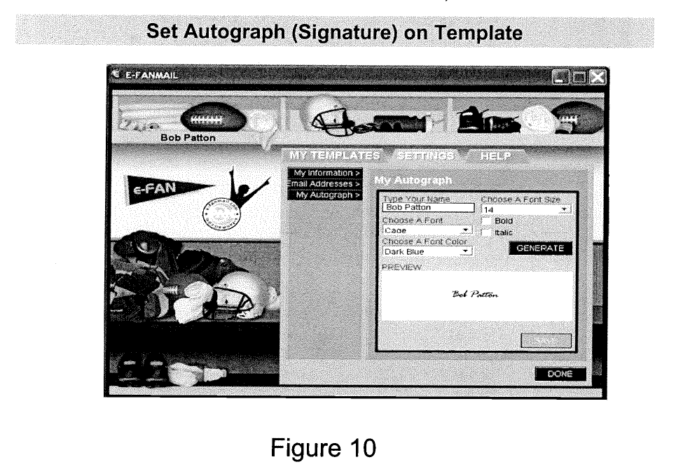

Typically, a subscriber performs configuration, customization and selection tasks at a website or using an application distributed by service and/or content providers. An example of web based configuration is shown in the screenshots of FIGS. 6-10. At step 302, a user typically selects a messaging or E-mail client. The client may be a web-based client or may be implemented on a local system or device. The subscriber may provide information regarding capabilities of the client and may be prompted to enter E-mail service provider addressing and identification information. In certain embodiments, the configuration tool may automatically detect E-mail client configuration in order to pre-populate selection options for the subscriber.

At step 304, the subscriber may select an area of interest. The area of interest may be a sport, performance arts such as a movie or series of movies, a hobby, social or political activity or any interest group. In certain cases, options may be offered in response to the selection. For example, a subscriber may follow a sequence of choices such as Sport, Football and NFL. At certain points, pricing options may be presented to the subscriber. For example, certain templates may be provided at no cost while selection of college and professional sports organizations may be licensed selections that are associated with a fee.

At step 306, where appropriate a team may be selected. In some embodiments, logo and graphics for both the team and a governing body or league may be presented in a finally selected template. Other selections may be offered such as a team member, NASCAR driver and so on. At step 308, the subscriber may select one or more preferred templates from a variety of options. The templates may be preconfigured with subscriber-specific information including selections of areas of interest and contact information. Furthermore, at step 310, the subscriber may customize the templates by, for example, selecting from content options and positions. At step 312, configured templates can be stored. Templates may be stored on a mail server and may further be stored in local storage.

In certain embodiments, a service provider may support content provided by a plurality of content providers. Content providers may license content to the service provider. In some embodiments, content providers may provide content to the service provider and receive a percentage of fees charged subscribers by the service provider. Additionally, advertising may be placed by content providers and third parties. For example, background content in certain templates may provide placement opportunities where, for example, a soft drink container may be situated on shelf or more prominently located in the template. Placement of advertising can be billed as a one-time fee or can be compensated on a per-view or per click basis.

In certain embodiments, an advertiser can provide a graphic for placement in the template. Typically the graphic is identifiable with the advertiser and may contain a logo, trademark, service mark, icon, an example of packaging, product image or other image recognizable by a viewer as relating to the advertiser. The graphic may be superimposed ion the template in a suitable location. In the soft drink example above, the graphic may be a picture of a bottle that can be placed next to an athlete; similarly, a corporate logo can be placed in a predetermined location reserved for sponsors in the template. Thus, for example, a promotional graphic of a bottle can be merged, superimposed or otherwise integrally grafted to one of the template images in the template such that the bottle appears to be part of the template image.

In certain embodiments, interactive templates offer opportunities for corporate advertising and sponsorships that may be sold for placement on the templates. For example; a click on a Bank of America credit card in a template may take a reader immediately to the bank's on-line credit card application. Sponsorship spots on the template may be rotated so that, for example, any of ten sponsors can be placed on each template. The number of sponsors in a rotation is not limited and can be selected according to the application and provider requirements.

In certain embodiments, advertising “watermarks” are provided. A watermark is typically provided as a background item similar in character to watermarks found in high quality papers. The watermark may be clearly discernible although it may comprise a washed-out logo or branded image or may be positioned beyond the primary area of focus of the message. In one example, a faded logo may be provided across substantially all of the message area or in an area offering links to external resources and websites. The logo can be faded by adjusting color, intensity, contrast, focus or any combination of such attributes. Logos may appear with an associated link such as a hyperlink or may be provided as or in a clickable area whereby a viewer can select the logo to obtain further information. In some embodiments, the watermark can be provided together with a separate identification of sponsorship. In some of these embodiments, a link to additional materials may be associated with the separate identification and the watermark could be free of links.

In certain embodiments, video, audio, animated and other content may be embedded in the template. Multimedia content may be provided as a link that is selectable by a reader of the message. In some embodiments, the multimedia content can be provided in a background player. For example, an image of a television could be placed in the template where the multimedia content is displayed in the viewing area of the television. In certain embodiments, video content may be identified as being provided by one or more sponsors and may be provided as a watermark. Watermarked video is typically played in the background and may be faded through adjustment of color, contrast and intensity. Audio associated with watermarked video may be provided at lowered volume.

In certain embodiments, multimedia content players can be activated upon display of the template and/or a subscriber message. Typically a control, such as an HTML link, an ActiveX control or other suitable objects may be referenced or embedded in the template. When the template is rendered for display, the control can cause a multimedia player to be activated and can identify content to be played by the player.

In certain embodiments, watermarked content may be brought to the foreground upon user selection, under control mechanisms provided in the template, after periods of inactivity or after occurrence of an event. Events may include execution of E-mail related commands such as send, receive. Events may also include timed events such as alarms and can also be derived from other sources.

### Additional Descriptions of Certain Aspects of the Invention

Certain embodiments of the invention provide systems and methods for customizing an electronic message, comprising the steps of selecting a template including a plurality of graphical images consistent with an affinity of a subscriber, combining the selected template with a message received from the subscriber to obtain a customized message, and transmitting the customized message to a recipient. In some of these embodiments, the combining is performed by an E-mail client. In some of these embodiments, the combining is performed by a server. In some of these embodiments, the selected template includes content preselected by the subscriber. In some of these embodiments, the selected template is selected by the subscriber from a plurality of customized templates. In some of these embodiments, the affinity of the template is associated with a sport.

Certain embodiments of the invention provide systems and methods for placing advertising in an electronic message, comprising providing a template to a user, the template including a plurality of graphical images consistent with an affinity expressed by the user, inserting a promotional graphic into the template, wherein the graphic is identified with an advertiser, and associating the promotional graphic with a link to information related to the advertiser, wherein the template and a user message form a customized E-mail message and wherein the template includes an area for receiving the user message. Some of these embodiments further comprise transmitting the customized E-mail to a recipient. In some of these embodiments, the promotional graphic is a logo. In some of these embodiments, the promotional graphic is presented as an integral component of one of the plurality of graphical images.

Certain embodiments of the invention provide systems and methods for watermarking an E-mail, comprising providing a template to a user, the template including a plurality of graphical images consistent with an affinity expressed by the user, inserting a watermark graphic into the template, wherein the graphic is identified with a sponsor, adjusting selected ones of characteristics of the promotional image to obtain a watermark, wherein the template and a user message form a customized E-mail message. Some of these embodiments further comprise associating the watermark graphic with a link to information related to the sponsor. Some of these embodiments further comprising transmitting the customized E-mail to a recipient. In some of these embodiments, the watermark graphic is a logo. In some of these embodiments, the logo is associated with the sponsor.

Certain embodiments of the invention provide systems and methods for adding multimedia content to an electronic message, comprising selecting a template including a plurality of graphical images consistent with an affinity of a subscriber, combining the selected template with a message received from the subscriber to obtain a customized message, and embedding a control in the template configured to initiate playback of multimedia content when the customized message is viewed. In some of these embodiments, the control operates to activate a multimedia player. In some of these embodiments, the multimedia player plays the content as a watermark. In some of these embodiments, the multimedia player presents the content as an integral component of one of the plurality of graphical images plays the content as a watermark. In some of these embodiments, the selected template includes content preselected by the subscriber and wherein the selected template is selected from a plurality of customized templates.

Certain embodiments of the invention provide systems and methods for operating a toolbar that customizes an E-mail message, the toolbar comprising a selection tool for selecting a template including a plurality of graphical images consistent with an affinity of a subscriber, wherein the selected template includes a message area, and the template is combined with a message received from the subscriber to generate a customized E-mail message. In some of these embodiments, the subscriber has access to a predetermined quantity of templates associated with an identified affinity of the subscriber. In some of these embodiments, the affinity is with a sports team. In some of these embodiments, the affinity is with an educational establishment. In some of these embodiments, the toolbar is provided as a plug-in to one or more E-mail clients.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method for customizing an electronic message, comprising:
selecting a template including a plurality of graphical images consistent with an affinity of a subscriber;
combining the selected template with a message received from the subscriber to obtain a customized message; and
transmitting the customized message to a recipient.

2. The method of claim 1, wherein the combining is performed by an E-mail client.

3. The method of claim 1, wherein the combining is performed by a server.

4. The method of claim 1, wherein the selected template includes content preselected by the subscriber.

5. The method of claim 4, wherein the selected template is selected by the subscriber from a plurality of customized templates.

6. The method of claim 5, wherein the affinity of the template is associated with a sport.

7. A method for placing advertising in an electronic message, comprising:
providing a template to a user, the template including a plurality of graphical images consistent with an affinity expressed by the user;
inserting a promotional graphic into the template, wherein the graphic is identified with an advertiser; and
associating the promotional graphic with a link to information related to the advertiser, wherein
the template and a user message form a customized E-mail message and wherein the template includes an area for receiving the user message.

8. The method of claim 6, and further comprising transmitting the customized E-mail to a recipient.

9. The method of claim 6, wherein the promotional graphic is a logo.

10. The method of claim 6, wherein the promotional graphic is presented as an integral component of one of the plurality of graphical images.

11. A method for watermarking an E-mail, comprising:
providing a template to a user, the template including a plurality of graphical images consistent with an affinity expressed by the user;
inserting a watermark graphic into the template, wherein the graphic is identified with a sponsor;
adjusting selected ones of characteristics of the promotional image to obtain a watermark, wherein
the template and a user message form a customized E-mail message.

12. The method for watermarking of claim 11, and further comprising associating the watermark graphic with a link to information related to the sponsor.

13. The method for watermarking of claim 11, and further comprising transmitting the customized E-mail to a recipient.

14. The method for watermarking of claim 11, wherein the watermark graphic is a logo.

15. The method for watermarking of claim 14, wherein the logo is associated with the sponsor.

16. A method for adding multimedia content to an electronic message, comprising:
selecting a template including a plurality of graphical images consistent with an affinity of a subscriber;
combining the selected template with a message received from the subscriber to obtain a customized message; and
embedding a control in the template configured to initiate playback of multimedia content when the customized message is viewed.

17. The method of claim 16, wherein the control operates to activate a multimedia player.

18. The method of claim 17, wherein the multimedia player plays the content as a watermark.

19. The method of claim 17, wherein the multimedia player presents the content as an integral component of one of the plurality of graphical images plays the content as a watermark.

20. The method of claim 1, wherein the selected template includes content preselected by the subscriber and wherein the selected template is selected from a plurality of customized templates.

21. A toolbar for customizing an E-mail message, comprising a selection tool for selecting a template including a plurality of graphical images consistent with an affinity of a subscriber, wherein the selected template includes a message area, and the template is combined with a message received from the subscriber to generate a customized E-mail message.

22. The toolbar of claim 21, wherein the subscriber has access to a predetermined quantity of templates associated with an identified affinity of the subscriber.

23. The toolbar of claim 21, wherein the affinity is with a sports team.

24. The toolbar of claim 21, wherein the affinity is with an educational establishment.

25. The toolbar of claim 21, wherein the toolbar is provided as a plug-in to one or more E-mail clients.
